(19) United States
(12) Patent Application Publication
(10) Pub. No.: US 2002/0196965 A1
(43) Pub. Date: Dec. 26, 2002

(54) Image transformation and analysis system and method

(76) Inventors: Edward S. Wallace, Phoenix, AZ (US); Christopher A. Lipinski, Mesa, AZ (US)

Correspondence Address: Susan Sutterfield Wilks, Schmeiser, Olsen & Watts LLP, 18 East University Drive, #101, Mesa, AZ, 85201, US

(21) Appl. No.: 09/888,346

(22) Filed: Jun. 22, 2001

(51) Int. Cl. G06K 9/00; G06K 9/40

(52) U.S. Cl. 382/131; 382/260

(57) ABSTRACT

An image analysis system which can take an image, especially a brain image obtained by CT scan, transform the image by calculating a gradient matrix, and provide information which can form the basis of a diagnosis for a particular pathology, especially ischemic stroke in the brain, and a method for using the system is disclosed. The image analysis system can analyze an image to determine the presence and size of a region of edema, acute free blood, a mass, sulcal effacement, and other conditions to generate a diagnosis or probability of ischemic stroke, hemorrhagic stroke, a mass or other pathology in the brain.

### BACKGROUND OF THE INVENTION

1. Technical Field

This invention relates to a system for transforming and analyzing medical image data of anatomical areas to assist with diagnosis of medical conditions where the anatomical regions may exhibit changes in cellular structure due to disease, injury or edema in that anatomical area.

2. Background of the Invention

When a blood clot occurs in a blood vessel, the surrounding tissue may react to the resulting decrease in blood flow in that vessel with ischemic injury and swelling or edema.

When a blood clot occurs in a blood vessel in the brain, it is an ischemic stroke. Using currently available imaging technology, it can be very difficult to capture and display the changes that occur in tissue including brain tissue as a result of ischemic injury with sufficient clarity to allow for diagnosis, especially soon after the blood clot occurs.

For example, a patient may display the same outward symptoms following an ischemic stroke, a stroke resulting from a blood clot in the brain, and a hemorrhagic stroke, a stroke resulting from a leaking or bleeding blood vessel in the brain. These symptoms may include one-sided weakness, slurred speech, and decreased cognitive function. The treatments for these two types of stroke can be very different. The preferred treatment for a blood clot—induced stroke may be the administration of “clot-busting” drugs called thrombolytic agents. Administration of these “clot-busting” drugs to a patient suffering from a hemorrhagic stroke may cause death.

Often, diagnosis is further complicated because it is required soon after the onset of symptoms. Drugs which destroy clots may only be effective in preventing damage to the tissues surrounding blood vessels if the drugs are administered during a small window of time when the damage is reversible. During these early hours of ischemic injury, before damage to surrounding tissue is profound, changes in the surrounding tissues are subtle and difficult to image using commonly available imaging techniques.

Therefore there exists a need for a diagnostic tool which will assist emergency room physicians, neurologists, radiologists and other diagnosticians to diagnose the severity of stroke and stroke subtypes, soon after the onset of stroke symptoms. There is a need for an analytical tool which is capable of illustrating and highlighting subtle cellular and pericellular changes in anatomic areas, in the brain for example, which are characteristic of ischemic injury due to blood clots. There is a need for an analytical tool which can illustrate early tissue disruption due to recent ischemic injury which is not visible with currently available imaging technology. And, there exists a need for a system to measure and assess multiple parameters which may be indicative of ischemic stroke and other pathology and generate an output which may be helpful to physicians to determine a probability for a particular disease state such as ischemic stroke of recent onset.

### SUMMARY OF THE INVENTION

A medical image data transformation and analysis system for assisting with diagnosis of ischemic injury and method for using the system are disclosed herein. The medical image data transformation and analysis system utilizes image data output from CT, MRI, X-RAY or other medical imaging systems, transforms the data to highlight gradient features and illustrate differences between areas of lower image density juxtaposed against areas of higher image density, and displays the transformed data in a useable format. The output format is optimized to show differences in tissue density, among other differences, and to illustrate areas of edema caused by stroke. Where there are areas of reduced gradient, there is an indication of edema as a result of ischemic stroke. This image transforming tool may be helpful to emergency physicians, radiologists and other diagnosticians in analyzing images to more accurately diagnose the presence and size of ischemic or hemorrhagic stroke. This image analysis tool may also search image data or transformed image data for evidence of acute free blood or a mass consistent with a tumor or an infection. The presence of acute free blood may indicate that an hemorrhagic stroke or traumatic event has occurred. This image analysis system may be used as a diagnostic tool to indicate the presence or absence of ischemic stroke, the severity and size of ischemic stroke, the presence or absence of hemorrhagic stroke or a mass or other pathology, taking into consideration a variety of factors.

The present system may also compile areas which are likely to be damaged due to ischemic stroke in the patient and compare to those same areas in a control or normal scan. A control scan may be a scan of the patient's own undamaged brain hemisphere. The system may also display control or normal scans next to scans of the same neuroanatomical region with known ischemic injury so that the physician or diagnostician can compare the normal and known injured state with the subject scan or transformed image.

Also disclosed herein is an image analysis method which can evaluate several factors to create an indication of probability or a diagnostic indicator of ischemic stroke, hemorrhagic stroke or other pathology. This image analysis method can measure and evaluate evidence such as reductions of gradient in specified neuroanatomical regions which might be indicative of ischemic injury and edema. The image analysis system can detect and consider evidence such as the presence or absence of free blood or a mass in the brain. In addition, the image analysis system can measure and consider the presence of sulcal effacement, or the reduction in overall amount of CSF present inside the skull, which is an additional indicator of ischemic injury or edema. The image analysis method can compile and evaluate these data, along with patient information, to create an output which can give the user an indication of a probability of a particular diagnosis, and information related to particular treatments for these diagnoses.

The foregoing and other features and advantages of the invention will be apparent from the following more particular description of preferred embodiments of the invention, as illustrated in the accompanying drawings.

### BRIEF DESCRIPTION OF THE DRAWINGS

The embodiments of the present invention will hereinafter be described in conjunction with the appended drawings, wherein like designations denote like elements, and:

FIG. 1 is a schematic representation of a slice from a CT scan of a brain;

FIGS. 2(A)-(C) are graphical representations of original image data and the effect of the present invention on original image data at a representative location in the brain;

FIGS. 3(A)-(C) are graphical representations of the original image data and the effect of the present invention on original image data at the representative location in the brain in an injured state;

FIGS. 4(A)-(C) illustrate an output of the present invention, the interface plot;

FIG. 5 illustrates a flow diagram of the Image Analysis method of the present invention;

FIG. 6 illustrates a signal flow diagram of the present invention.

### DETAILED DESCRIPTION OF THE EMBODIMENTS

A medical image analysis system for assisting with early diagnosis of injury due to ischemic stroke and methods for using the system are disclosed herein. An apparatus for providing the medical image analysis system is disclosed, along with methods for implementing the system. In one embodiment, the image analysis consists of algorithms applied to medical image data to transform and change the data and create output which highlights particular features of the data which may not be visible in the absence of the algorithms. In another embodiment, the image analysis system consists of a series of algorithms and analyses applied to image data to create visible structures and to search for features present in the data, to compile and evaluate the results of these analyses and to provide an output which may be helpful to a diagnostician.

Stroke is currently the third most common killer in the United States, according to the American Stroke Association. Ischemic stroke accounts for 70 to 80 percent of all strokes, according to the American Heart Association. In recent years, studies have indicated that early treatment of ischemic stroke with “clot-busting” or thrombolytic drugs such as recombinant tissue plasminogen activator (r-tPA or tPA), may improve short term and long term functional outcome for ischemic stroke patients.

However, this treatment is controversial and dangerous. The American Heart Association and the American Stroke Association recommend treatment with thrombolytic agent only if the patient falls within very narrow clinical parameters. These very narrow clinical parameters include diagnosis of ischemic stroke established by neurological deficit and by computer aided tomography (CAT or CT). The CT must be read by a physician with expertise in interpretation of CT. And, treatment must be initiated within three hours of onset of stroke symptoms. Transporting a patient to an emergency room, obtaining a CT scan and properly reading the CT, and administering treatment all within a period of three hours from onset of symptoms is a very narrow window.

Identifying ischemic stroke from the CT scan, especially so soon after onset of stroke can be very difficult. Ischemic stroke results in edema or swelling in those tissues directly affected by the loss of blood flow caused by a clot. When a blood clot occludes a blood vessel, cells in the area fed by that blood vessel experience loss of oxygen and nutrients. During ischemia, edema forms in the cellular and extracellular compartments as a result of vasogenic and cytotoxic mediators, but not necessarily cell death. This disruption, when it occurs in an area in which there is a clear distinction between gray matter and white matter, results in a blurring of the distinction, or a smoothing of the transition between gray and white on CT scan. Soon after an ischemic event, while damage to the injured tissue is still minimal, this blurring or smoothing can be very difficult to detect by CT scan. In addition, soon after an ischemic event, this disruption is reversible.

Studies indicate that administration of thrombolytic drugs outside the American Heart Association's recommended narrow three hour window of time may lead to bad outcomes, including intracranial hemorrhage and death. And, if a drug which lyses clots is administered to a patient who has suffered or later suffers intracranial hemorrhage, that patient risks severe neurological damage and death. At the same time, because treatment with thrombolytic drugs is recommended by the American Heart Association, it may be considered to be standard of care for emergency physicians and other care givers. Given these parameters, fast and accurate reading of CT scans to identify early damage associated with ischemic stroke is extremely important to both patients and doctors.

Usually, CT scans of the head and brain are presented to the physician in the form of a film displaying successive slices through the head. The film is then placed on a light box for analysis by the physician. Useful output of typical CT scanners is limited to a range of grays which are visible and distinct to the human eye.

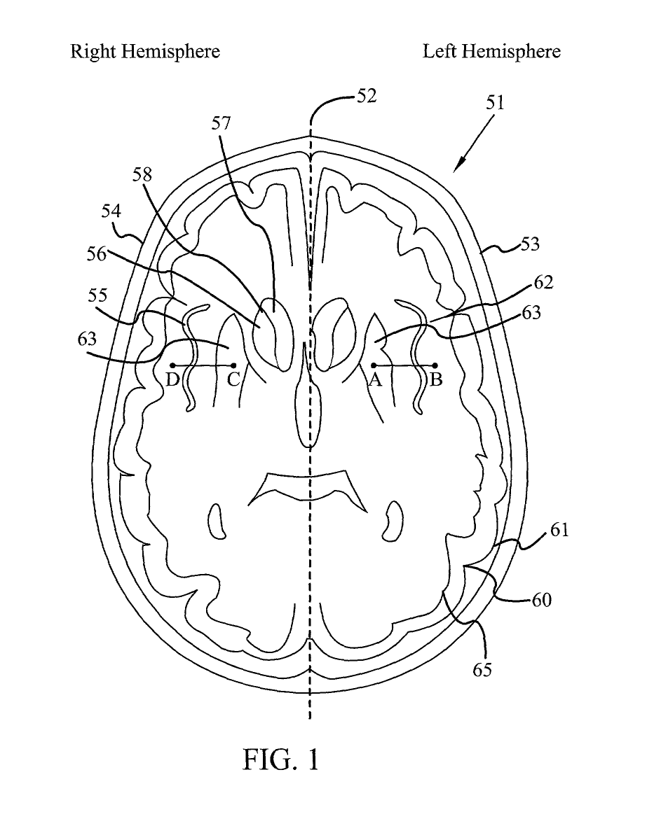

FIG. 1 is a schematic representation of a slice from a CT scan 51 of a brain. Note that in reading CT scans, the right hemisphere of the brain is by convention on the left side of the page and the left hemisphere of the brain is on the right side of the page. The CT scan representation is divided down the midline 52. The right hemisphere 53, on the left side of midline 52, represents the CT scan of a patient suffering from ischemic stroke. The left hemisphere 54, on the right side of midline 52, represents the CT scan of a normal patient. Illustrated in both the left hemisphere 53 and right hemisphere 54 are several regions of interest. These regions include the insular stripe 55, the region of the caudate nucleus 56 as it juxtaposes against the region of the anterior horn of the lateral ventricle 57 to define an interface 58 between the caudate nucleus 56 and the anterior horn of the lateral ventricle 57, and the sulci 60, gyri 61 and fissures 62 which comprise the indentations in the surface of the brain.

CT image data is available in digital form. Digital CT scan data is available as data output files, the standardized version of which is called a DICOM file. DICOM files render digital CT scans as voxels, typically in a 512×512 array or matrix where each voxel is representative of a level or composite intensity of X-Ray radiation received within each discrete picture element during an exposure. In CT scans, these intensities are typically reported in Houndsfield Units. Houndsfield Units are standardized units of intensity in CT images. In other imaging technologies, the units or levels of intensity may be reported in other unit systems which will be well known to those of ordinary skill in the art. Digital data residing in a DICOM or other files may be filtered, manipulated, transformed, optimized, transformed, processed or otherwise changed to highlight desired features such as a particular range of contrast, and reduce undesired features such as noise, image bending or image bleeding.

In the brain, white matter, composed of axons, is more dense than grey matter which is composed of nerve cell bodies. White matter appears on a CT scan as a higher intensity in Houndsfield Units (or a whiter region on CT scan) than grey matter (which appears as less dense, or darker on CT scan). Ventricles 57 contain cerebrospinal fluid (CSF). CSF is liquid which is less dense than either gray matter or white matter and appears black on CT scans.

The subtle reduction in contrast which occurs as an early result of ischemic stroke may be most visible by CT scan in areas in which there are typically abrupt changes between white matter and grey matter or brain and CSF. These neuroanatomical areas include the insular stripe 55, the interface 58 between the caudate 56 and the anterior horn of the lateral ventricle 57, and at the interface between gray matter and white matter along the cortex 65. The diagnostician must look at the CT scan and determine if the neuroanatomical areas in the brain which normally exhibit a discernable step from a dark area on the CT scan to a light area on the CT scan now exhibit a less discemable step from a dark area to a light area as a result of edema.

Other changes may occur with ischemic stroke and edema including sulcal effacement, a decrease in the total volume of CSF around the brain, as the brain itself swells, pushing the liquid CSF out of the brain cavity. To assess sulcal effacement, the diagnostician may be required to examine each slice of the brain from the CT scan to develop an overall impression of likelihood of edema. In addition, the diagnostician may look for the presence or absence of free blood in the brain. The presence of acute free blood, which is visible on CT scans as a light area, is indicative of a stroke of hemorrhagic origin and would contraindicate the use of thrombolytic drugs.

In FIG. 1, the right side of the brain (left hemisphere) represents a CT scan from a normal, uninjured brain. Line A-B represents a line across the insular stripe 55 on the right, uninjured side of a CT scan. In FIG. 1, the left side of the brain (right hemisphere) represents a CT scan illustrating an ischemic stroke. Line C-D represents a similar line across the insular stripe 55 on the left, injured side. While FIG. 1 is presented with an injured side and a control side, this is not an uncommon circumstance for actual stroke victims. Stroke usually occurs on one side or the other in the brain. The other, uninjured hemisphere can be used by the diagnostician as a control. In a standard CT scan grey scale image, as represented by FIG. 1, there is little or no difference between the right hemisphere and left hemisphere to indicate the presence or absence of ischemic injury or edema.

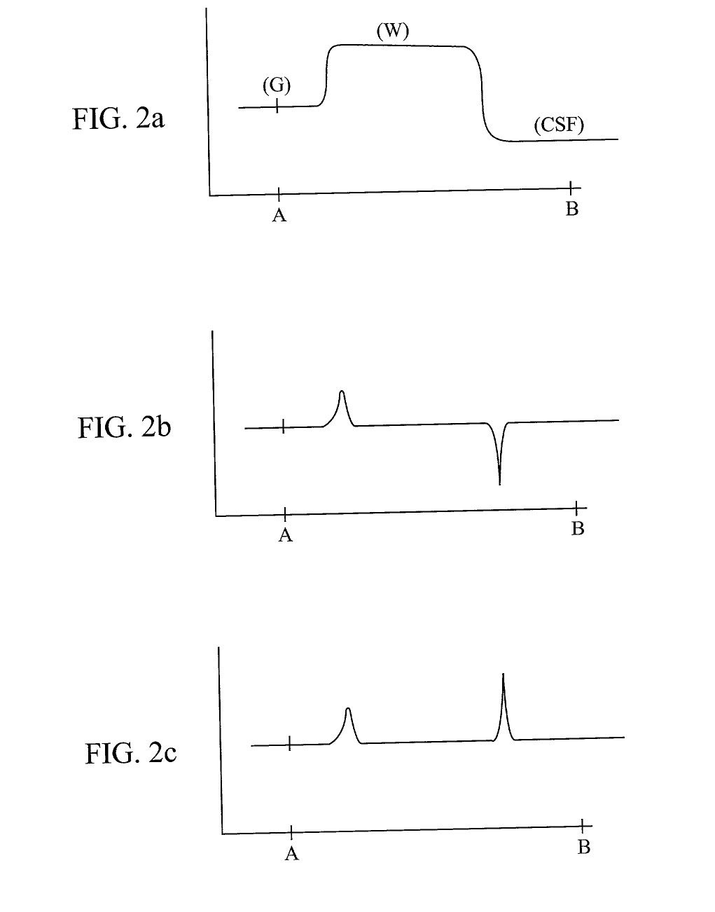

FIGS. 2(A)-2(C) illustrate the effect of the algorithms disclosed herein applied to image data. A sample of image matrix data, representing corresponding Houndsfield Unit data, along line A-B. Lines A-B is shown in FIGS. 2(A)-2(C) as an illustration of the effect of the algorithms of the present invention on data from one region where the algorithms are most advantageous. In applying the algorithms, a sample of data may be extracted from the larger image matrix representing the entire CT scan, or the algorithms can be applied to the whole data file as provided by a CT scanner or other image generating technology. Data may be extracted from image data either manually, by user choice, or automatically. To extract such data manually, the user may view digital image data on a screen or other output device, mark the image to delineate an area of interest and enter a command to transform that data by applying a specific algorithm or set of algorithms. To extract data automatically, anatomical areas or features consistently of interest may be identified as a function of data analysis. For example, a particular slice of a typical CT scan may contain a region typically referenced to diagnose ischemic stroke. This slice may be automatically earmarked for analysis. The particular area of interest, for example the region of the insular stripe, may be identified and earmarked for analysis. Or, an entire data file, representing each successive CT slice, can be filtered, manipulated, transformed, optimized, processed or otherwise changed to highlight and display desired features in the data.

FIG. 2 illustrates original image data and the effect of the present invention on original image data at a representative location in the brain, along line A-B in FIG. 1. This data may be extracted from a DICOM file. In FIG. 2(A), this data is intensity data in Houndsfield Units as it might appear in an image data file. The data may have already been optimized and filtered for display as a readable CT scan image. FIG. 2(A) is a graph representing intensities along line A-B in FIG. 1. Line A-B travels across an area of grey matter in the putamen 63, across the white matter of the insular stripe 55, to the sylvian fissure which contains CSF. Grey matter (G) is represented at a first intensity, in Houndsfield Units, white matter (W) is represented at a second (higher) intensity level, and CSF is represented at a third (lower) intensity. The insular stripe or insular cortex is fed by the middle cerebral artery (MCA). This blood vessel is a common locus of both blood clots and cerebral bleeding. If a blood clot occurs at this location, at the level of the MCA, the surrounding tissue, including the insular stripe 55, would likely show signs of ischemic injury and edema soon after the onset of the stroke.

The image data along line A-B can be manipulated in order to maximize the user's ability to visualize loss of definition between gray matter and white matter in specific areas of the brain on a CT scan. For example, a gradient can be calculated. The gradient is a measurement of the rate of change in values of Houndsfield Units between individual data points in a one-dimensional, two dimensional or three dimensional array of image data. A gradient can also be described as a directional vector, a derivative, a directional derivative, a negative gradient, a directional gradient or any other measurement of change between adjacent data points in an array of data.

H=[raw data matrix](in Houndsfield Units)

G=−gradient [H]

FIG. 2B is a two dimensional graphical representation of the gradient data which is generated when the gradient is calculated from the image data. FIG. 2B is a two dimensional graphical representation of the gradient data in the normal state.

To further enhance the viewer's ability to diagnose ischemic stroke from the CT scan, the gradient data can be rectified (i.e. the absolute value of the gradient matrix data can calculated).

A=abs(G)

or

A=|G|.

This rectified gradient data is illustrated in FIG. 2(C). In FIG. 2(C), changes in density are represented by two positive deflections of the graph. FIG. 2(C) is representative of analysis performed on a one-dimensional array of data. Similar analysis can be performed in two or three dimensions to create two dimensional interface plots or three-dimensional interface plots of rectified gradient data. Rectifying the data, as illustrated in FIG. 2(C) allows equal deflections indicating gradients from white to gray and from gray to white to be treated equally by the system.

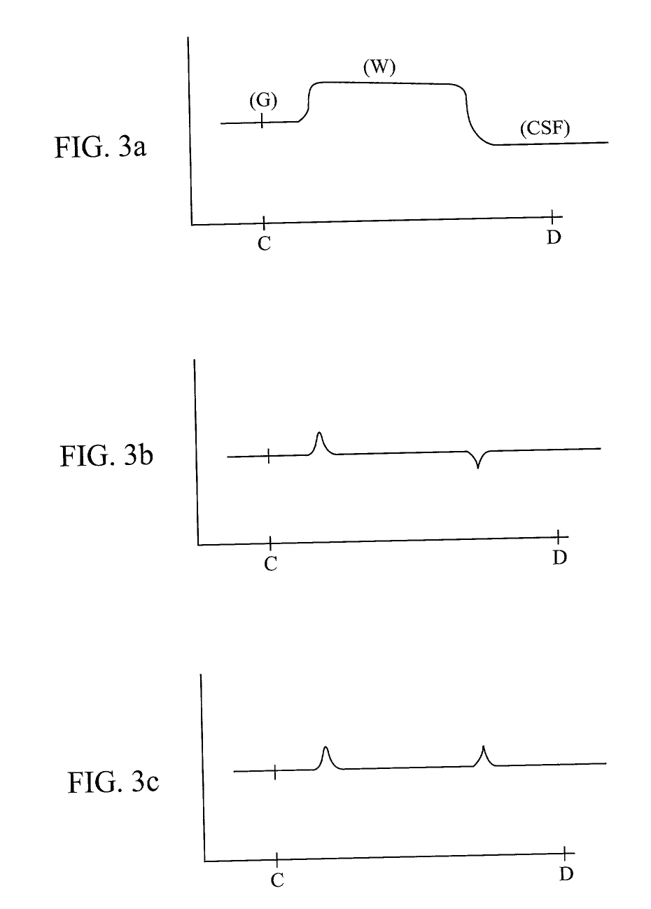

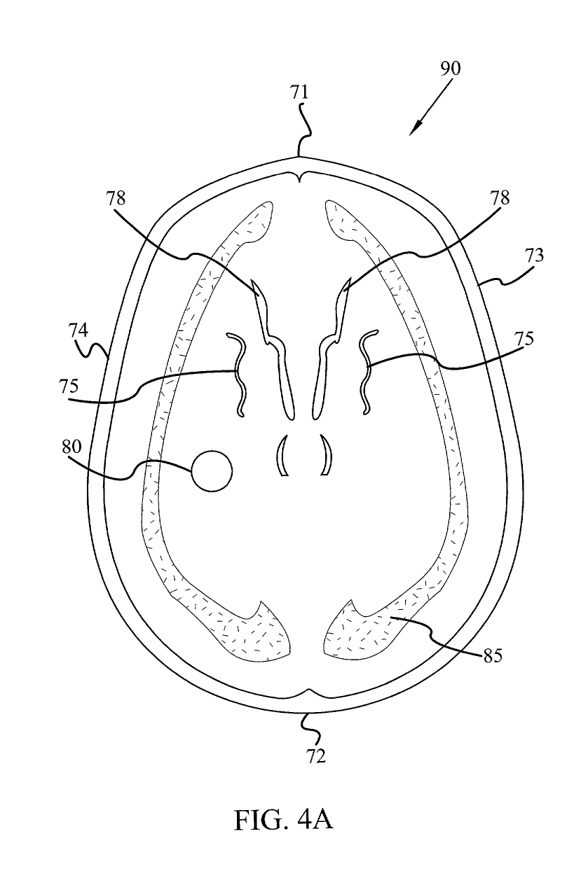

Similarly, FIG. 3 illustrates original image data and the effect of the present invention on original image data at a representative location in the brain, along line C-D in FIG. 1, representing the injured state. In FIG. 3(A), grey matter (G) is represented at a first intensity in Houndsfield Units, white matter (W) is represented at a second (higher) intensity level, and CSF is represented at a third (lower) intensity. FIG. 3(A) is a graphical representation of the image data along line C-D in FIG. 1, representing the injured state. FIG. 3(B) is a graphical representation of the gradient data as it might represent an injured area. FIG. 3(C) is a graphical representation of the rectified gradient data taken from the injured area. FIGS. 3(A)-(C) illustrate that in the injured state, the gradients are reduced compared to FIGS. 2(A)-(C) and that reduction of gradient is associated with ischemic injury and edema.

Filters may also be employed to eliminate noise or unwanted signals from the original image data, or in the rectified gradient data. For example, a filter may be used before a gradient is calculated to eliminate background noise or other spurious signals from the image data. Or, a filter such as a sensitivity may be set in the rectified gradient data so that any deflection less than a specified level is set back to zero, and only gradients of a magnitude greater than that specified level are displayed.

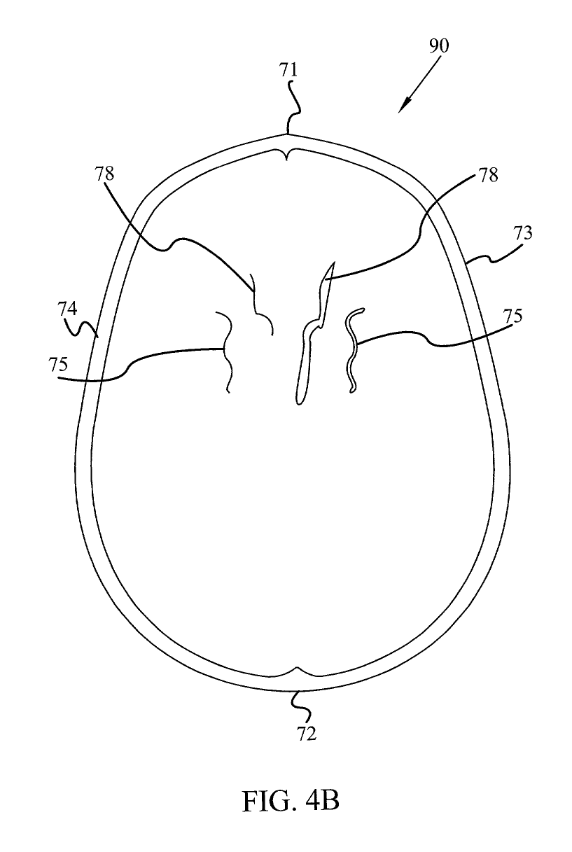

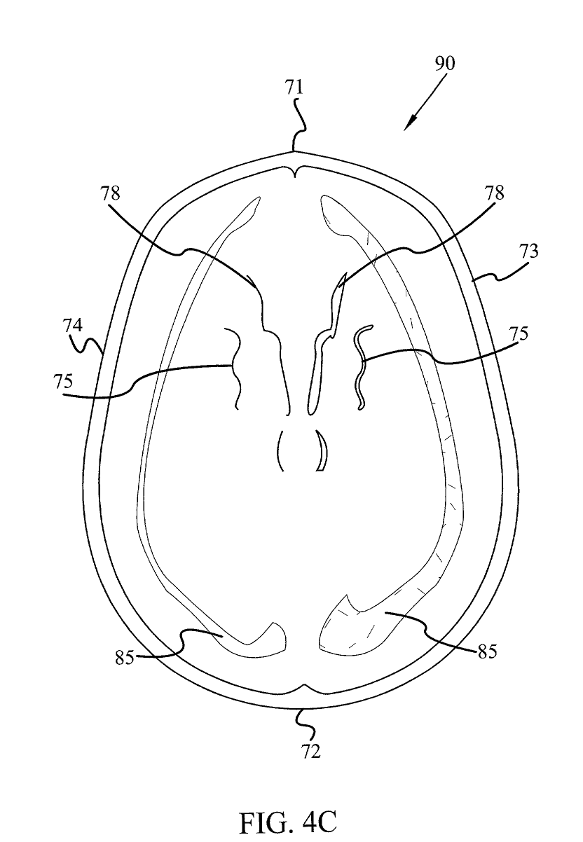

FIG. 4 illustrates representative images which might result from the application of the preceding algorithms to image data representative of a single slice from a CT scan. FIGS. 4(A)-4(C) illustrate Interface Plots 90. Each Interface Plot 90 has an anterior end 71, a posterior end 72, a left hemisphere 73 and a right hemisphere 74. Interface plots are images generated from the rectified gradient data illustrating areas which have a defined gradient between adjacent data points in the raw data readings measured in Houndsfield Units. For example, where a CT scan would show an area of white matter juxtaposed against an area of grey matter or juxtaposed against an area of CSF, there exists a gradient. Interface plots display areas of defined gradients as structures. These displayed Interface Plot structures are associated with juxtapositions of neuroanatomical areas which have a defined gradient between adjacent intensity readings. Because a filter may be applied to the rectified gradient data, only areas of defined gradient magnitudes will be illustrated as structures in the Interface Plot. Areas where gradients are not within the defined range will not be illustrated on the Interface Plot. Furthermore, areas of different gradient magnitudes may be illustrated as different colors or different shades of grey to indicate the magnitude of the gradient in that area.

FIG. 4(A) illustrates a normal or control interface plot as it might appear after image data has been transformed using the following algorithms or commands:

(1) H=[raw data matrix](in Houndsfield Units)

(2) G=gradient −[H]

(3) A=|G|

(4) S=[sensitivity matrix]

(5) I=A−S

(6) plot I

Equation (1) is the raw image data expressed as a matrix in Houndsfield Units. Equation (2) calculates the negative gradient between adjacent data points. This equation transforms the raw intensity data in Houndsfield Units to a measurement of the rate of change between intensities of adjacent data points. Equation (3) rectifies the gradient data, or takes the absolute value of the gradient data. Equation (4) creates a sensitivity matrix where all values are set to the sensitivity. This sensitivity can be adjusted up or down to accentuate or remove features of the interface plot. This is a filtering step. Equation (5) applies the filter defined in Equation (4) to the negative gradient data to define the interface values to be displayed. The level of the filter may be set by the user to remove spurious signals while leaving areas of sufficient gradient magnitude visible in the Interface Plot. The level of the filter can be adjusted depending on the application. Statement (6) is a command to display the rectified, filtered gradient data as an Interface Plot. These equations constitute an image data transformation mechanism. The processed image can be output to any output device including but not limited to display on a screen, printed onto paper or films, downloaded to a storage device, sent via an Internet or Intranet, etc.

FIG. 4(A) illustrates an Interface Plot in a control, uninjured state. FIG. 4(A) illustrates Interface Plot structure which indicates a gradient between white and gray matter and white matter and CSF in the region of the insular stripe 75, the transition between the caudate nucleus and the anterior horn of the lateral ventricle 78, and a ring of Interface Plot structure which indicates the gray-white cortical interface 85. In the control, uninjured state, these Interface Plot structures are clearly visible bilaterally in the Interface Plot 90.

FIG. 4(B) illustrates an Interface Plot 90 as it might appear after the onset of stroke symptoms. This Interface Plot has been filtered so that the Interface Plot structure at the grey-white cortical interface is not visible. This Interface Plot illustrates a significant loss of Interface Plot structure in the right hemisphere 73 (left side of page) in the region of the insular stripe 75. This Interface Plot also illustrates a significant loss of Interface Plot structure in the right hemisphere (left side of page) in the region of the interface/transition 78 between the caudate nucleus and the anterior horn of the lateral ventricle. This reduction of Interface Plot structure in the right hemisphere (left side of page) indicates a reduction in the gradients between adjacent neuroanatomical areas as measured by a CT scan, when compared to the left hemisphere (right side of page). This reduction in the gradient is indicative of edema formation in the right hemisphere (left side of page).

These Interface Plots 90 provide information to the diagnostician which was either not visible prior to the application of the algorithms, or was so subtle as to be indistinguishable from the control or normal state prior to the application of the algorithms. Interface Plots 90 give the diagnostician information which more clearly and definitely indicates changes in tissue due to ischemic injury or edema shortly after a stroke. Interface Plots 90 can be provided alongside traditional CT scan images to give diagnosticians an additional image to analyze in making a diagnosis of early onset ischemic stroke. These Interface Plots can be displayed on video monitors in black and white or in color or printed on film to be displayed on a light box. Or, the data contained in the Interface Plots, namely the reduction of gradients between adjacent neuroanatomical areas, can be reduced to a probability of ischemic stroke. For example, if the Interface Plot displays a 25% reduction in gradient, that might correlate to a 50% probability of ischemic stroke. These correlations can be calculated by using large numbers of CT scans taken from large numbers of patients with known ischemic stroke to calculate population probabilities.

FIG. 4(C) illustrates another Interface Plot 90 as it might appear after the onset of stroke symptoms. This Interface Plot illustrates a significant loss of Interface Plot structure in the right hemisphere 74 (on the left side of the page) in the region of the insular stripe 75. In addition, this Interface Plot illustrates a subtle loss of Interface Plot structure in the right hemisphere in the region of the interface/transition 78 between the caudate nucleus and the anterior horn of the lateral ventricle. Finally, this plot illustrates that there is still significant Interface Plot structure visible in the region of the gray/white cortical interface 85, however, this Interface Plot structure is reduced on the side of the stroke, as indicated by a reduction in the hatch-marks in FIG. 4(C). This reduction of Interface Plot structure in the right hemisphere (left side of page) indicates a reduction in the gradients between adjacent neuroanatomical areas as measured by a CT scan, when compared to the left hemisphere (right side of page). This reduction in the gradient is indicative of edema.

In summary, FIGS. 4(A)-4(C) illustrate Interface Plots which allow a diagnostician to see changes in gradients which indicate edema. FIGS. 4(A)-(C) illustrate a decrease in the gradient between white matter and grey matter and CSF, which indicates a homogeneity in the tissue which was not present in the control plot, and which is not present in the unaffected hemisphere. This tissue homogeneity indicates ischemic injury and edema. The location of injury visible on an Interface Plot may be different if the stroke resulted from a clot or occlusion of a blood vessel located in a different area of the brain. For example, if the stroke resulted from a blood clot closer to the interface between the grey and white matter in the cortex, the cortical interface may show a decrease in gradient measurements while the insular stripe may not.

This image analysis system can be utilized in tissues other than brain. For example, in the liver, changes in density of tissues indicates disease and may occur slowly over a long period of time. Cirrhosis occurs over a period of years and is visible using commonly available imaging techniques as a gradual change in density and homogeneity of the tissue. Images of these slow changes over time can be difficult to compare. However, using an image analysis system such as the system disclosed herein, an image taken via CT scan, MRI, X-ray or other image generating device can be analyzed using an Interface Plot to evaluate the degree of tissue homogeneity and thus the progression of the disease. This type of analysis could also be applied in the kidney, the lung, or other tissues to identify variation in tissue homogeneity which might represent a disease state.

Injury following ischemic stroke may follow a progression. The severity of injury, as represented by the loss of gradient Interface Plot structure in Interface Plots such as those illustrated in FIGS. 4(A)-(C) may increase with the severity of the stroke and the time since the stroke occurred. A more complex series of diagnostic questions may be helpful in determining both the presence of ischemic stroke (as differentiated from hemorrhagic stroke) and the severity or time since onset of symptoms. Such a series of diagnostic questions could comprise an image analysis method 300 or image analysis mechanism which could be a tool to use, to determine the etiology and severity of ischemic stroke or other brain pathology and to create an output which defines a probability that the patient has suffered an ischemic stroke and/or an indication or contraindication to treat the patient with clot-busting drugs.

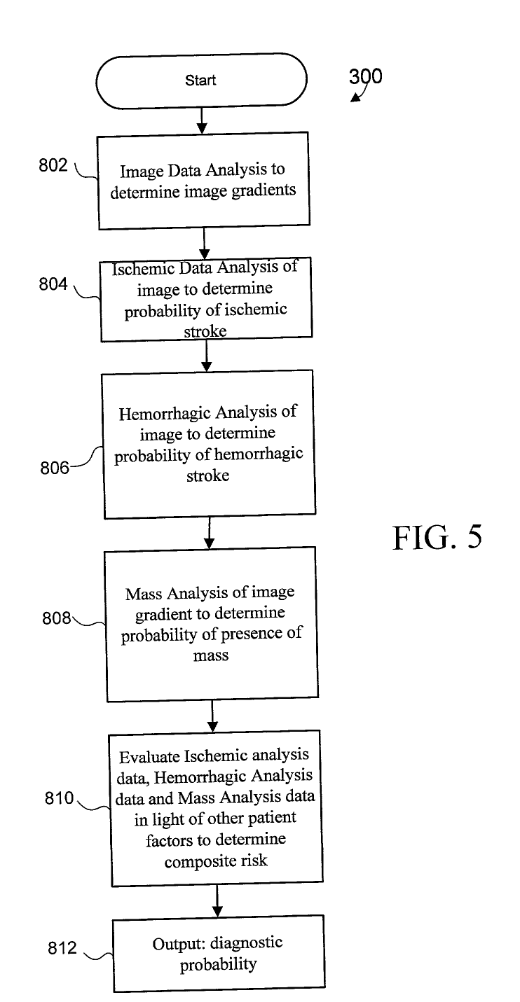

FIG. 5 illustrates a flow diagram of the image analysis method 300 which can be used to assist diagnosticians to evaluate data from the image analysis system of the present invention along with additional information to diagnose brain pathology. The image analysis method 300 illustrated in FIG. 5 constitutes an image analysis system or an image analysis mechanism. The image analysis method 300 can be used when a CT scan is taken and a diagnostician wishes to obtain and analyze additional information to assist with diagnosis. The information obtained from the patient, from the CT scan and from the further analysis of the CT scan data such as the Interface Plot, could be used to output a probability that an Ischemic stroke, hemorrhagic stroke, or other brain pathology is present. The image analysis method 300 could also consider other factors such as patient risk factors and other patient information to calculate and indicate risks or other considerations in particular treatment regimes such as treatment with thombolytic agents.

The image analysis method 300 compiles and analyzes Interface Plot data to determine image gradients in step 802. The image analysis method 300 constitutes an image analysis system or image analysis mechanism. The image analysis method 300 can be implemented using an image analysis system or an image analysis mechanism or an image transforming mechanism. FIG. 5 illustrates several types of analyses which may be applied to image data. These analyses are illustrative and not exhaustive of the types of image analysis steps which can be performed according to the present invention. The image analysis method 300 illustrates analyses including an Ischemic Analysis step 804, an Hemorrhagic Analysis step 806, a Mass Analysis step 808 and an Evaluation step 810 which compiles and evaluates the information gathered in the previous analyses along with other patient information to determine a composite diagnosis (or a probability of diagnosis) and/or a composite risk for particular treatments. These analysis steps constitute image analysis mechanisms. These analyses are image analysis systems or may be combined and interrelated to create an expert system or a neural network. The order of the analyses is not important, and FIG. 5 is not intended to illustrate steps which must be performed in a particular order.

FIG. 5 illustrates an Ischemic Analysis step 804. This Ischemic Analysis step 804 constitutes an edema detection mechanism, an image analysis mechanism, an image analysis system or an image data transformation mechanism. The Ischemic Analysis step 804 is an analysis of the Interface Plot information as described above, to determine if there has been a loss of gradients in the data which may be a result of edema or ischemic stroke. For example, if the Interface Plot reflects a loss of gradients which are normally present in the brain, in the area of the insular stripe, in the area of the interface between the caudate nucleus and the anterior horn of the lateral ventricle, or in the grey/white cortical interface, as discussed above, the image analysis method 300, in the Ischemic Analysis step 804 may provide an output indicating a positive probability for ischemic stroke.

The Ischemic Analysis 804 can analyze data to determine the specific location of edema. Ischemic Analysis 804 can be performed without manual input from the operator. Patients are imaged by CT scan lying on their backs. In every head CT scan, the anterior/posterior axis of the brain will be essentially uniformly located. The skull defines the edges of useful data in a head CT. The skull in a head CT is represented by a bright line, representing the high density of the bone of the skull. In addition, human brains exhibit a significant degree of symmetry between the two hemispheres about this anterior/posterior axis. An algorithm which recognizes and defines symmetry about the midline may be used to define the midline for each CT scan.

The region of the insular stripe is a unique anatomical region present in approximately the same location from patient to patient, as shown by CT scan. The neuroanatomical area of the insular stripe is apparent in approximately the same CT slice(s) which is an indication of the depth of the neuroanatomical area in relation to the top of the head of the patient. In addition, the neuroanatomical area is located at approximately the same location in relation to the midline and the anterior/posterior coordinates of the skull of the CT scan. Given these three dimensions, the insular stripe, or the caudate nucleus, or any neuroanatomical region of interest in the brain can be identified as a region of interest in image data. This region can be identified in the Interface Plot by identifying the approximate location of that data within the rectified gradient image data, and searching for Interface Plot structure in that location in the Interface Plot. Reduction of Interface Plot structure can be assessed by comparing the Interface Plot structure present in one hemisphere of the imaged brain to Interface Plot structure present in the other hemisphere of the imaged brain or by comparing the data to control data acquired from Interface Plots generated from a population of control CTs. Because stroke is generally a condition present in one hemisphere or the other, the unaffected hemisphere can act as a control for data from the affected hemisphere. If such loss of Interface Plot structure in the region of the insular stripe is found in the Interface Plot, the output of the image analysis system may be “Use of thrombolytic agent may be indicated” or “probability of ischemic stroke is high.” This output comprises a diagnostic indication of brain pathology. Alternatively, data accumulated over many trials may provide control data. If a loss of Interface Plot structure is not found in the Interface Plot, the probability of ischemic stroke may be low. The system may output a message indicating that the probability of ischemic stroke is low. In addition, the system may further analyze the data to determine other factors such as risk for drug treatment, etc.

The image analysis method 300 may make more complex evaluations of the patient. For example, the Image analysis method 300 could quantify the degree of loss of Interface Plot structure in the region of the insular stripe on Interface Plot. This information could be helpful in determining the level of damage that has already occurred, and in making an estimation of the time since onset of stroke. While the use of a thrombolytic drug may be indicated if a minor loss of Interface Plot structure is detected, the use of a thrombolytic drug may be contraindicated if a major loss of Interface Plot structure is detected. For example, if a minor loss of Interface Plot structure in the insular stripe is detected, the ischemic stroke may be of more recent onset and the use of thrombolytic drugs may be more effective. However, if a major loss of Interface Plot structure is detected including the insular stripe, the interface between the caudate nucleus and the anterior horn of the lateral ventricle and the cortical grey-white interface, the ischemic stroke may be large or may have occurred outside the window of effective treatment with the drug.

Also illustrated in FIG. 5 is a Hemorrhagic Analysis 806. The Hemorrhagic Analysis 806 constitutes an image data transformation mechanism, a free blood detection mechanism and a image analysis mechanism. The Image analysis method 300 could examine CT scan image matrix data to determine if there is acute free blood present in the CT scan image matrix. Acute free blood is present in CT scans in a unique range of intensity at approximately 50 Houndsfield Units. If any readings are present in this range throughout the image data, and the readings are not associated with blood in blood vessels, the Hemorrhagic Analysis 806 step can create output which indicates that there is acute free blood present in the CT scan. Acute free blood, particularly microscopic acute free blood may not be visible by looking at a CT scan. This output could be forwarded to the Evaluation step 810 which could develop an output 812 indicating a relatively positive probability of hemorrhagic stroke and/or a relatively negative probability of ischemic stroke. In addition, the presence of acute free blood is a contraindication for the use of thrombolytics and a contraindication for a diagnosis of ischemic stroke. The output could also provide a statement indicating a contraindication for treatment with thrombolytic agents. The output 812 could include a statement such as “Do Not Thrombolyse” or similar output statement.

The image analysis method may also include a Mass Analysis 808 to determine whether the image contains a feature which may be a mass or tumor or infection. The Mass Analysis 808 constitutes an image data transformation mechanism, a mass detection mechanism and an image analysis mechanism. A mass is an area in the brain which consists of a different density tissue than the surrounding tissue. A mass may be present as a tumor or a site of infection. This area of tissue will be reflected in the Interface Plot as an area with structure about a region with different density tissue. Because a tumor or locus of infection is generally an isolated region with defined borders, this Interface Plot structure will illustrate a defined, enclosed area whose borders or edges will create an enclosed area on the Interface Plot. The enclosed area may be circular. The Mass Analysis 808 could search for enclosed areas or regions on Interface Plots to determine if there is a mass present in the brain. This mass structure 80 is illustrated in FIG. 4(A). If the Mass Analysis 808 determines that there is a mass structure 80 present in the Interface Plot data, this information, when considered in the Evaluation step 810 may create output 812 such as “High Probability of Mass.”

The Evaluation step 810 of the image analysis method 300 is the step where all of the data collected from patients and analyzed in the Analysis steps are collected, sorted and analyzed to create an output 812. The Evaluation step is an evaluation mechanism, an image analysis mechanism, and an image analysis system. The Evaluation step 810 of the Image analysis method 300 may consider the results of each of these image analysis steps, Ischemic analysis 804, Hemorrhagic analysis 806, Mass analysis 810, in light of additional patient information. Patient information may include any question or series of questions which would indicate, contraindicate or relatively contraindicate the use of thrombolytic drugs or another particular treatment, even in the face of a favorable probability for a diagnosis of ischemic stroke. Patient information may also include other types of information including the individual's smoking status, family history, family history of stroke or other diseases, etc. Answers to these questions can be asked by the system and input by the user at the time of image acquisition. These decision rules might be based on questions such as: Has the patient had recent major surgery?; Is the patient taking blood-thinning medications?; Does the patient have a blood-clotting disorder?, Has it been more than three hours since the onset of stroke symptoms?, etc. If the answers to these questions contraindicate the use of thrombolytic drugs, the system may consider this information in the Evaluation step 810 to create output such as “Use of Thrombolytics Contraindicated” etc.

The Evaluation step 810 may include compiling and comparing information from populations of patient information passing through the Image analysis method which may provide additional complex information relating to potential outcomes and probabilities and risks of a particular finding from a particular patient. The Evaluation step 810 can provide additional information to output 812. The image analysis method 300 may also lend more weight to the outcome of some questions over others. This weighting step could take place in the Evaluation step 810. And, the system may use different kinds of information, in different orders, to determine probabilities or indications of ischemic stroke, hemorrhagic stroke or other brain pathology. The image analysis system could also be used to define other disease states in other organs or locations.

As described above, the Output 812 may consist of statements of probabilities of a particular diagnosis, or a risk of a particular treatment. Output 812 may consist of a red or green coloration for a particular diagnosis, a circle around a particular diagnosis or treatment with a line through the circle indicating “do not,” a stop sign associated with a particular diagnosis or treatment, or other like statements. Output 812 may provide significant information for research, diagnosis and treatment purposes including correlations between results of several analyses. For example, if the Ischemic Analysis indicates the presence of ischemic stroke and the Hemorrhagic Analysis indicates the presence of microscopic bleeding in the brain, the system could compile these results for later analysis of outcome for the patient associated with different treatment regimes.

While FIG. 5 illustrates one embodiment of the image analysis system and method, FIG. 5 is intended to be illustrative and not exhaustive. Additional questions may be asked. For example, questions such as: “Does the Interface Plot show decrease in Interface Plot structure related to the grey/white interface at the cortical stripe?”; and “Is there sulcal effacement? may be asked. Sulcal effacement can be measured by a sulcal effacement image data transformation mechanism or image analysis mechanism. This mechanism could scan the medical image data to measure the total volume of CSF, which is measured in a unique range of intensity in Houndsfield Units. Alternatively, the sulcal effacement mechanism could scan the medical image data to measure the total volume of brain, which is measured in the unique range of intensity for brian tissue. Sulcal effacement can be limited to the hemisphere which is the location of injury, or sulcal effacement can be evident throughout the brain. Reduction of total volume of CSF could be a two-part inquiry. First, the sulcal effacement mechanism could ask if one hemisphere displays less total volume of CSF than the other hemisphere. Then, the mechanism could ask if the total volume of CSF is less compared to a normal or control measurement. A normal or control measurement could be defined as a population figure by making the measurement over a large population of CT scans with known absence or presence of stroke.

Because human perception is limited, the grey scale is limited that can be effectively used in CT scan output is limited. Therefore, CT scan films which are optimized to show neuroanatomical features may show regions which contain dense or opaque tissues such as blood, bone, tumor, sites of infections or other dense tissues, as saturated areas (which appear white) on CT scan films. Blood and bone are both usually highly visible as a white areas on a CT scan. However, distinguishing between blood and bone can be extremely difficult in a typical head CT. Because areas of blood and areas of bone intensities are both saturated on the grey scale, it can be extremely difficult for a physician to distinguish between a subarachnoid, subdural or epidural hemorrhage. In these areas, between thin layers of tissue between the brain and the skull, if the CT scan is optimized to show neuroanatomical tissue, it may be extremely difficult to discern the exact location of blood. The precise location of bleeding may be extremely important for the patient. Treatment for these different types of bleeding may be different. This image analysis system or image analysis mechanism can also be used to identify regions which are blood which has a Houndsfield Unit (HFU) reading of approximately 50 HFU and bone which can be measured at over 1000 HFU. For example, image data can be accessed and analyzed for the presence of intensities in the intensity range associated with blood, and can be displayed as a blood plot to illustrate the presence of free blood in the brain. This type of plot could be useful for visual diagnosis of the presence of acute free blood in the brain.

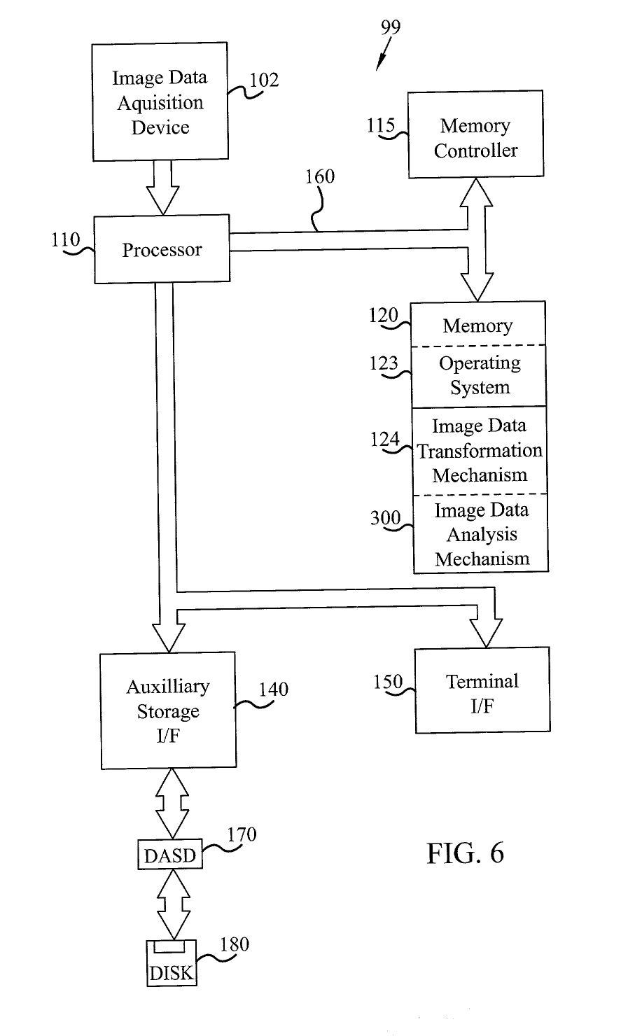

Referring now to FIG. 6, a computer system in accordance with an embodiment of the image analysis system 99 includes: an image data generating device or image data acquisition device 102 a central processing unit (CPU) or processor 110; a terminal interface 150; an auxiliary storage interface 140; a Direct Access Storage Device (DASD) 170; a floppy disk 180; a bus 160; a memory controller 115 and a memory 120. In this system 99, memory includes an operating system 123, an image data transformation mechanism 124 and an image data analysis mechanism 300. It should be understood that bus 160 is used to load image data files into processor 110 and to load image data transformation mechanism 124 into memory 120 for execution.

The image data acquisition device or image data generating device 102 can be a CT scanner, an X-Ray machine, MRI, PET scanner or any other image data generating device 102. The acquisition device 102 can be remote from the processor 110 or can be integral to the processor 110.

The processor 110 or Central Processing Unit (CPU) performs computation and control functions of system 99. The CPU 110 associated with system 99 may comprise a single integrated circuit, such as a microprocessor, or may comprise any suitable number of integrated circuit devices and/or circuit boards working in cooperation to accomplish the functions of a central processing unit. CPU 110 is capable of suitably executing the programs contained within memory 120 and acting in response to those programs or other activities that may occur in system 99.

Memory 120 is any type of memory known to those skilled in the art. This would include Dynamic Random Access Memory (DRAM), Static RAM (SRAM), flash memory, cache memory, etc. While not explicitly shown in FIG. 6, memory 120 may be a single type of memory component or may be composed of many different types of memory components. In addition, the functions of image data acquisition device 102, memory 120 and CPU 110 may be distributed across several different computers that collectively comprise system 99. Computer system 99 of FIG. 6 simply illustrates many of the salient features of the invention, without limitation regarding the physical location of the CPU 110 or memory locations within memory 120. In addition, although image data transforming mechanism 124, and image data analysis mechanism 300 are shown to reside in the same memory location as operating system 123, it is to be understood that memory 120 may consist of disparate memory locations.

Memory controller 115, through use of a processor (not shown) separate from processor 110, is responsible for moving requested information from main memory 120 and/or through auxiliary storage interface 140 to processor 110. While for the purposes of explanation, memory controller 130 is shown as a separate entity, those skilled in the art understand that, in practice, portions of the function provided by memory controller 115 may actually reside in the circuitry associated with processor 110, main memory 120, and/or auxiliary storage interface 140.

Bus 160 serves to transmit programs, data, status and other forms of information or signals between the various components of system 100. Bus 160 is any suitable physical or logical means of connecting computer systems and components known to those skilled in the art. This includes, but is not limited to, direct hard-wired connections, Internet connections, Intranet connections, fiber optic connections, infrared (IR) and other forms of wireless connections. In addition, bus 160 in its most generic sense refers to transmitting data between components of the system 99 by physically transferring data or other information located on a disk or CD-ROM or other storage media from one component to another component. It is anticipated that many alternative methods and material for connecting computer systems and components will be readily adapted for use with the present invention. this would include those methods and materials not presently known but developed in the future.

Terminal interface 150 allows human users to communicate with system 99. Terminal interface 150 represents any method of human user communication with a computer system. Auxiliary storage interface 140 represents any method of interfacing a storage apparatus to a computer system known to those skilled in the art. Auxiliary storage interface 140 allows auxiliary storage devices such as DASD 170 to be attached to and communicate with the other components of system 99. While only one auxiliary storage interface 140 is shown, the present invention anticipates multiple interfaces and multiple auxiliary storage devices such as DASD 170. As shown in FIG. 5, DASD 170 may also be a floppy disk drive which is capable of reading and writing programs or data on disk 180. DASD 170 may also be any other type of DASD known to those skilled in the art. This would include floppy disk drives, CD-ROM drives, hard disk drives, optical drives, memory sticks, memory chips, etc. Disk 180 represents the corresponding storage medium used with DASD 170. As such, disk 180 can comprise a typical 3.5 inch magnetic media disk, an optical disk, a magnetic tape or any other type of storage medium.

Operating system 123 is any operating system suitable for controlling system 99. Image transforming mechanism 124 resides in memory 120 and is any set of algorithms such as those illustrated above capable of altering image data to enhance particular features of that image data. These image transforming algorithms may include a gradient algorithm and a rectification algorithm and may also include filters and sensitivity setting algorithms. It is important to note that while the present invention has been (and will continue to be) described in the context of a fully functional computer system, those skilled in the art will appreciate that the mechanisms of the present invention are capable of being distributed as a program product in a variety of forms, and that the present invention applies equally regardless of the particular type of signal bearing media to actually carry out the distribution. Examples of signal bearing media include: recordable type media such as floppy disks (e.g. disk 180) and CD-ROMS, and transmission type media such as digital and analog communication links, including wireless communication links.

While the invention has been particularly shown and described with reference to preferred embodiments thereof, it will be understood by those skilled in the art that various changes in form and details may be made therein without departing from the spirit and scope of the invention.

I claim:

1. An apparatus comprising:
a medical image data file, the medical image data comprised of voxels, each voxel corresponding to an intensity value at a location within an image;
a processor;
a memory coupled to the processor;
an image data transformation mechanism residing in the memory, the image data transformation mechanism transforming the medical image data; calculating a gradient between voxels in the medical image data to create gradient data;
rectifying the gradient data to create interface data; and displaying the interface data as output.

2. The apparatus according to claim 1 wherein the image data transformation mechanism further comprises a filter to filter the interface data to remove spurious interface data.

3. The apparatus according to claim 1 wherein each voxel is an intensity in Houndsfield Units.

4. The apparatus according to claim 1 wherein the output comprises an Interface Plot wherein said Interface Plot is an image of interface data which illustrates gradient features in the medical image data.

5. The apparatus according to claim 1 further comprising an image generating device to generate the medical image data file.

6. The apparatus according to claim 1 wherein the medical image generating device is a CT scanner.

7. The apparatus according to claim 1 wherein the medical image data file comprises a CT scan of a brain.

8. The apparatus of claim 1 further comprising an image analysis mechanism residing in memory wherein the image analysis mechanism renders an output comprising a diagnostic indication of brain pathology.

9. The apparatus of claim 8 wherein the image analysis mechanism comprises a free blood detection mechanism to detect the presence of intensity readings within the medical image data which indicates the presence of acute free blood in the brain.

10. The apparatus of claim 8 wherein the image analysis mechanism comprises a mass detection mechanism to detect the presence of gradient data which defines an enclosed structure indicative of a mass in the brain.

11. The apparatus of claim 8 wherein the image analysis mechanism comprises an edema detection mechanism to detect the presence of a decrease in gradient at a neuroanatomical region compared to the gradient measured in the corresponding region in the opposite hemisphere of the brain.

12. The apparatus of claim 11 wherein the neuroanatomical region is one of the insular stripe, the interface between the caudate nucleus and the anterior horn of the lateral ventricle, and the cortical grey/white interface.

13. The apparatus of claim 9 wherein the image analysis mechanism comprises an evaluation mechanism.

14. The apparatus of claim 9 wherein the medical image data file comprises a CT scan of a brain and wherein the image data transformation mechanism displays the interface data as an Interface Plot illustrating gradient structures in corresponding locations in the brain.

15. An apparatus for assisting with diagnosis of brain pathology comprising:
brain image matrix data, the brain image matrix comprised of voxels;
a processor;
a memory coupled to the processor;
an image data transformation mechanism residing in the memory, the image data transformation mechanism taking the brain image matrix; calculating a gradient between the voxels to create a gradient matrix; rectifying the gradient matrix to create an interface matrix; applying a filter to create a filtered interface matrix;
and displaying the filtered interface matrix as output for assisting with diagnosis of brain pathology.

16. The apparatus according to claim 15 wherein the output comprises an Interface Plot wherein said Interface Plot is an image of the filtered interface matrix which illustrates gradient features in the brain image matrix data.

17. The apparatus according to claim 15 further comprising an image generating device to generate the brain image matrix data.

18. The apparatus according to claim 17 wherein the image generating device is a CT scanner.

19. The apparatus of claim 15 further comprising an image analysis mechanism residing in memory wherein the image analysis mechanism renders an output comprising a diagnostic indication of brain pathology.

20. The apparatus of claim 19 wherein the image analysis mechanism comprises a free blood detection mechanism to detect the presence of intensity readings within the medical image data which indicates the presence of acute free blood in the brain.

21. The apparatus of claim 19 wherein the image analysis mechanism comprises an edema detection mechanism to detect the presence of a decrease in gradient in the neuroanatomical region compared to the gradient measured in the corresponding region in the opposite hemisphere of the brain.

22. The apparatus of claim 21 wherein the neuroanatomical region is one of the insular stripe, the interface between the caudate nucleus and the anterior horn of the lateral ventricle, and the cortical grey/white interface.

23. A program product comprising:
(A) a brain image data transformation mechanism, the brain image data transformation mechanism using brain image data comprised of voxels in Houndsfield Units to calculate a gradient between the voxels to create gradient data; rectifying the gradient data to create interface data; applying a filter to create filtered interface data; and displaying the filtered interface matrix data as output;
(B) signal bearing media bearing the brain image data transformation mechanism.

24. The program product according to claim 23 wherein the output comprises an Interface Plot.

25. The program product according to claim 23 wherein the brain image data comprises data from an image generating device.

26. The program product according to claim 24 wherein the image generating device is a CT scanner.

27. The apparatus of claim 21 further comprising an image analysis mechanism residing in memory which renders an output comprising a diagnostic indication of brain pathology.

28. The apparatus of claim 27 wherein the image analysis mechanism comprises a free blood detection mechanism to detect the presence of free blood in the brain.

29. The apparatus of claim 27 wherein the image analysis mechanism comprises an edema detection mechanism to detect the presence of a decrease in gradient at a neuroanatomical region compared to the gradient measured in the corresponding region in the opposite hemisphere of the brain.

30. The apparatus of claim 29 wherein the neuroanatomical region is one of the insular stripe, the interface between the caudate nucleus and the anterior horn of the lateral ventricle, and the cortical grey/white interface.

31. A method for assisting with the diagnosis of brain pathology comprising:
obtaining a brain image comprised of voxels arranged in an image matrix;
calculating a gradient between voxels to create a gradient data matrix;
rectifying the gradient data to create a rectified gradient data matrix;
applying a filter to the rectified gradient data to create filtered rectified gradient data matrix;
generating an output from the filtered rectified gradient data.

32. The method of claim 30 wherein the output comprises an Interface Plot.

33. The method of claim 30 further comprising an image generating device.

34. The method of claim 33 wherein the image generating device is a CT scanner.

35. The method of claim 30 further comprising an image analysis mechanism which renders an output comprising a diagnostic indication of brain pathology.

36. The method of claim 35 wherein the image analysis mechanism comprises a free blood detection mechanism to detect the presence of acute free blood in the brain.

37. The method of claim 35 wherein the image analysis mechanism comprises an ischemic injury detection mechanism to detect the presence of a decrease in gradient at a neuroanatomical region compared to the gradient measured in the corresponding neuroanatomical region in the opposite hemisphere of the brain.

38. The method of claim 37 wherein the neuroanatomical region is one of the insular stripe, the interface between the caudate nucleus and the anterior horn of the lateral ventricle, and the cortical grey/white interface.

39. A method for diagnosing brain edema comprising the steps of:
obtaining a digital matrix CT scan image;
transforming the digital matrix CT scan image to create gradient data;
generating output which illustrates the gradient data;
analyzing the output to determine if edema is present.

40. A method for diagnosing brain pathology comprising the steps of:
obtaining a digital matrix brain image;
analyzing the brain image to find acute free blood;
analyzing the brain image to find sulcal effacement;
transforming the digital matrix brain image to create a transformed brain image;
analyzing the transformed brain image to find edema;
analyzing the transformed brain image to find a mass;
compiling the analyses to generate an output;
wherein the output comprises an indication of diagnosis of brain pathology.

41. The method of claim 40 further comprising obtaining patient information.

42. The method of claim 41 further comprising analyzing patient information.
